(19) United States
(12) Patent Application Publication
(10) Pub. No.: US 2026/0366926 A1
(43) Pub. Date: Nov. 19, 2026

(54) PIEZOELECTRIC SENSOR, COMPRISING A RELIEF, FOR A MOTOR VEHICLE

(71) Applicant: Continental Automotive Technologies GmbH, Hannover (DE)

(72) Inventors: Bertrand Varoquie, Eaunes (FR); Eric SENECHAL, Cugnaux (FR)

(73) Assignee: Continental Automotive Technologies GmbH, Hannover (DE)

(21) Appl. No.: 19/372,428

(22) Filed: Oct. 29, 2025

(30) Foreign Application Priority Data
Nov. 22, 2024 (FR) FR2412838

(51) Int. Cl. G01K 1/024; G01K 1/08; G01K 1/14; G01K 7/22; H02K 11/25

(52) U.S. Cl. CPC G01K 1/024; G01K 1/08; G01K 1/14; G01K 7/22; H02K 11/25

(57) ABSTRACT

A sensor for measuring a parameter for a motor vehicle, including an elongated body having at least one lateral face extending between a distal end, having a raised shape projecting from said at least one lateral face. The body including, along the at least one lateral face, at least one fluid discharge channel extending from the distal end to the proximal end. The sensor further including a piezoelectric element and a measurement element.

### CROSS REFERENCE TO RELATED APPLICATIONS

This application claims priority to French Application No.2412838, filed Nov. 22, 2024, the contents of such application being incorporated by reference herein.

### FIELD OF THE INVENTION

The present invention pertains to the field of motor vehicles and more specifically relates to a raised piezoelectric sensor for a motor vehicle.

### BACKGROUND OF THE INVENTION

As is known, an electric motor comprises a rotor and a stator. The operation of such a motor causes the rotor and the stator to heat up. However, the increase in temperature of the rotor can lead to performance losses and to the demagnetization of the magnets placed therein beyond a certain temperature, which can lead to damage or even failure of the motor. Therefore, the temperature inside the rotor needs to be measured in order to be able to reduce the speed thereof when the temperature approaches the critical operating limit, thereby preventing the motor from being damaged or even failing.

The temperature of the rotor is difficult to measure directly using wired temperature sensors because the rotor rotates during operation, and the temperature is therefore estimated using algorithms and models integrated into the management system of the motor.

However, these integrated algorithms and models lead to measurement errors of possibly up to approximately 20°C, which is unsatisfactory for controlling the motor to prevent it from being damaged or failing.

A simple, reliable and efficient solution for at least partly overcoming these disadvantages therefore would be advantageous.

### SUMMARY OF THE INVENTION

To this end, an aspect of the invention is first of all a sensor for measuring a parameter for a motor vehicle, said sensor comprising an elongated body comprising at least one lateral face extending between a distal end, having a raised shape projecting from said at least one lateral face, and a proximal end, said body comprising, along the at least one lateral face, at least one fluid discharge channel extending from the distal end to the proximal end, said sensor further comprising a piezoelectric element and a measurement element, said piezoelectric element being mounted inside the body adjacent to the distal end and being configured to receive an ultrasonic power supply signal and to electrically power said measurement element from said ultrasonic power supply signal, the measurement element being mounted inside the body while being electrically connected to the piezoelectric element and being configured, when electrically powered by the piezoelectric element, to measure the parameter, to generate a measurement signal representing the value of said parameter at a given time, and to transmit said measurement signal to the piezoelectric element, said piezoelectric element being configured to convert said measurement signal into an ultrasonic response signal and to transmit said ultrasonic response signal.

The at least one channel allows fluid to be discharged when the sensor is inserted into a reception space, for example formed in a rotor or in a casing.

The sensor according to an aspect of the invention is used to take remote measurements by means of the remote module by powering the sensing measurement element with the energy from signals sent by the main module over a wireless link. This enables the measurements to be taken as close as possible to the magnets, thereby enhancing the control performance of the electric machine. An aspect of the invention also allows metal barriers to be crossed, such as, for example, the casing and the protective flanges, which block electromagnetic Wi-Fi or Bluetooth waves. The sensor according to an aspect of the invention is easy to insert into a reception space by virtue of its profiled distal end, which also allows fluids to be expelled from said reception space. The one or more fluid discharge channels allow fluids, notably air, to be discharged outside when the sensor is inserted into the reception space, in order to improve the quality of the transmissions and receptions of ultrasonic signals by the piezoelectric element.

In one embodiment, the conduction element is a thermal conduction element, preferably made of aluminum or copper.

Advantageously, the piezoelectric element extends along a plane.

Preferably, the plane is orthogonal to the longitudinal axis of the body of the sensor.

According to one aspect of the invention, the distal end has a concave or pointed shape, for example, a conical shape.

In one embodiment, the at least one discharge channel is a groove formed on the surface of the body of the sensor or even a duct formed in a lateral face of the body of the sensor.

An aspect of the invention also relates to a casing for a sensor, said casing comprising a molding of material defining a reception space in which a sensor as described above is mounted.

Preferably, the casing comprises a magnet embedded in the molding material so as to be flush with the reception space.

An aspect of the invention also relates to an electric machine for a motor vehicle, said electric machine comprising a stator, a rotor and a sensor as described above, said electric machine being configured to be mounted in said vehicle in order to set into rotation the wheels of said vehicle, in which electric machine the main module is mounted on the stator and the sensor is mounted inside the rotor.

An aspect of the invention also relates to a battery or a pack of batteries or a fuel cell for a motor vehicle, comprising a measurement sensor as described above, with the sensor respectively being mounted inside said battery or inside at least one battery of the pack of batteries or inside the fuel cell.

An aspect of the invention also relates to a motor vehicle comprising a sensor as described above.

An aspect of the invention also relates to a motor vehicle comprising an electric machine as described above or a battery as described above or a pack of batteries as described above or a fuel cell as described above.

An aspect of the invention also relates to a method for mounting a sensor as described above in a reception space of a motor vehicle, said reception space being dimensioned to receive said sensor without any clearance, said method comprising the steps of:
applying an adhesive at least to the distal end of the body of the sensor;
inserting the distal end of the sensor into the reception space;
discharging, when the distal end of the sensor reaches the bottom of the reception space, the fluids present in the reception space through the at least one discharge channel so as to secure the sensor in the reception space.

An aspect of the invention also relates to a method for measuring a parameter using a sensor as described above, said method comprising the steps of:
the main piezoelectric transceiver transmitting an ultrasonic power supply signal to the sensor;
the piezoelectric element of the sensor receiving the transmitted ultrasonic power supply signal;
the piezoelectric element electrically powering the measurement element using the electrical energy contained in the received ultrasonic power supply signal;
the measurement element measuring the parameter when it is electrically powered by the piezoelectric element;
the measurement element generating a measurement signal representing the value of said parameter at a given time;
the measurement element transmitting said measurement signal to the piezoelectric element;
the piezoelectric element converting the measurement signal into an ultrasonic response signal;
the piezoelectric element transmitting said ultrasonic response signal;
the main piezoelectric transceiver receiving the transmitted ultrasonic response signal;
the main piezoelectric transceiver transmitting the received ultrasonic response signal to the control stage;
the control stage determining the measured temperature value in the received ultrasonic measurement signal.

Advantageously, the method comprises a step in which the control stage controls the speed of the rotor as a function of the determined temperature value.

### BRIEF DESCRIPTION OF THE DRAWINGS

Further features and advantages of aspects of the invention will become more apparent upon reading the following description. It is purely illustrative and should be read with reference to the appended drawings, in which:

FIG. 1 is a schematic longitudinal section view of an embodiment of the sensor according to the invention;

FIG. 2 is a schematic longitudinal section view of a reception space formed in a rotor and comprising the sensor of FIG. 1;

FIG. 3 is a schematic longitudinal section view of an embodiment of the electric machine according to the invention;

FIG. 4 schematically illustrates an example of the three-stage mounting of the sensor in a casing;

FIG. 5 schematically illustrates an embodiment of the mounting method according to the invention;

FIG. 6 schematically illustrates an embodiment of the measurement method according to the invention.

### DETAILED DESCRIPTION OF EXEMPLARY EMBODIMENTS

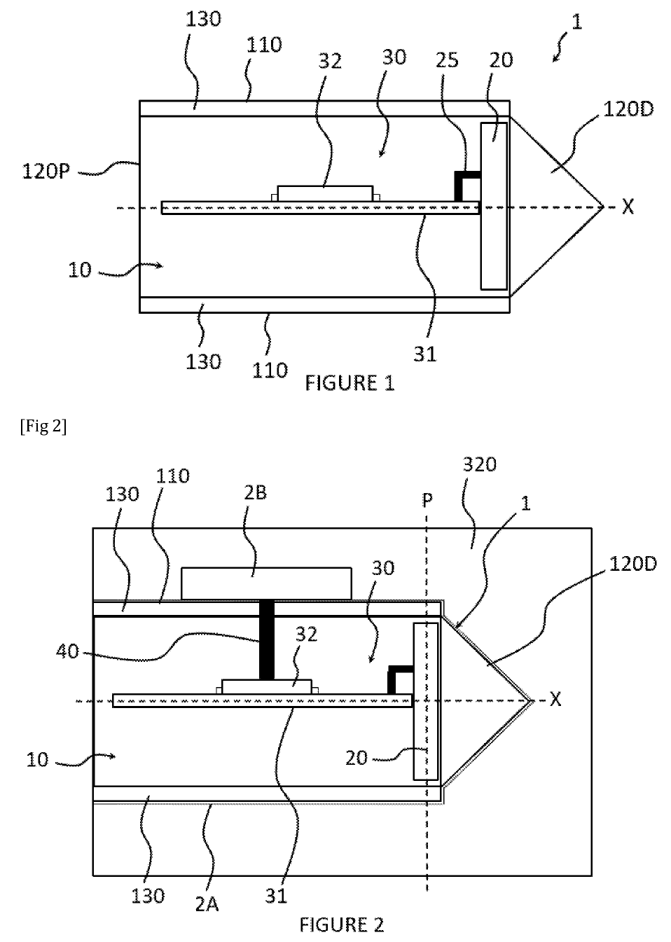

FIG. 1 shows an example of a sensor according to an aspect of the invention and FIG. 2 shows an example of a reception space comprising the sensor.

The sensor allows a parameter to be measured, such as, for example, the temperature, the pressure, a torque, a force or any other parameter that needs to be measured.

The sensor is intended to be mounted in a motor vehicle.

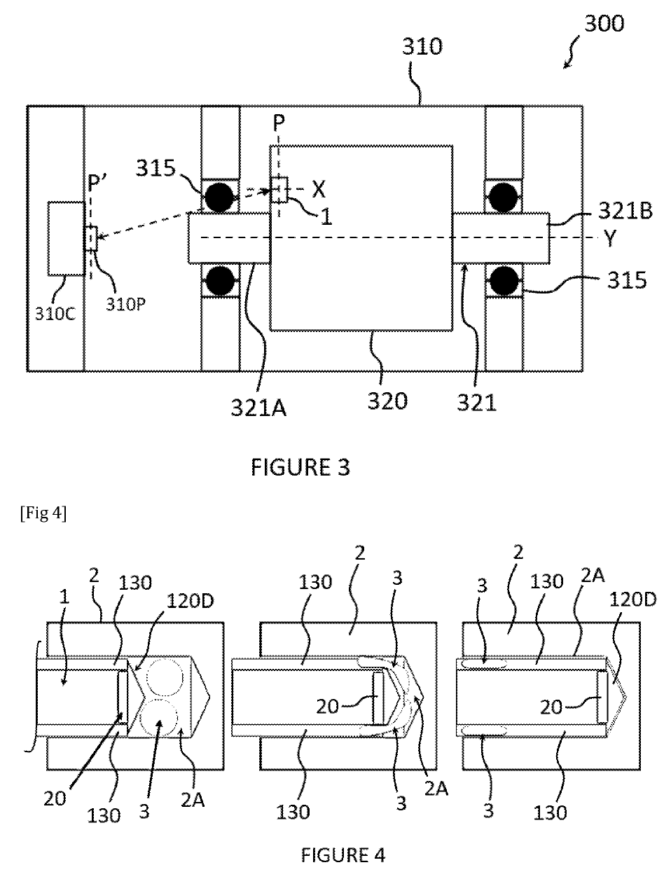

Preferably, and as provided by way of example throughout the remainder of this description, the sensor is intended to be mounted in a rotor of an electric machine of a motor vehicle, as illustrated in FIG. 3, which will be described hereinafter.

The sensor comprises a body, a piezoelectric element and a measurement element.

The body is at least partially hollow and assumes an elongated shape, for example a tubular or parallelepipedal shape. In the example in the figures, the body has a circular cross section.

The body comprises a lateral face extending between a proximal end and a distal end.

The distal end has a raised shape projecting from the lateral face. In the example in FIG. 1, the distal end has a conical shape.

The body comprises two fluid discharge channels, which in the example in FIG. 1 assume the form of two ducts extending from the distal end to the proximal end and emerging outside at each end. These ducts equally allow liquids such as, for example, water or adhesive, and air to be discharged.

The piezoelectric element is mounted inside the body adjacent to the distal end.

In the example in FIG. 2, the piezoelectric element is placed behind the distal end cone and extends along a plane orthogonal to the longitudinal axis of the body of the sensor in order to improve the reception and transmission of ultrasonic signals with a main piezoelectric transceiver of the stator (FIG. 3), as will be explained hereinafter.

The piezoelectric element is configured to receive an ultrasonic power supply signal (referenced in FIG. 6) and to electrically power the measurement element from said ultrasonic power supply signal.

The measurement element comprises an electrical circuit board mounted inside the body and electrically connected to the piezoelectric element via an electrical connector.

The measurement element is configured, when electrically powered by the piezoelectric element, to measure the parameter, to generate a measurement signal (referenced in FIG. 6) representing the value of said parameter at a given time, and to transmit said measurement signal to the piezoelectric element.

In the example in FIG. 2, the measurement element comprises a resistor (or a thermistor) mounted on the electrical circuit board, the resistance of which varies as a function of the temperature. The measurement signal in this case is the voltage applied across the terminals of said resistor (or said thermistor).

The piezoelectric element is configured to convert the measurement signal into an ultrasonic response signal (referenced in FIG. 6) and to transmit said ultrasonic response signal to the main piezoelectric transceiver of the stator. In other words, the piezoelectric element is configured to transmit the measurement signal in the form of an ultrasonic signal.

In the example in FIG. 2, the sensor further comprises a conduction element connecting the measurement element to the outside of the sensor through the lateral face. Preferably, this conduction element is in the form of a blade, a rod or a bar, notably made of metal.

When the sensor is a temperature measurement sensor, as illustrated in this example, the conduction element is a high thermal conduction element, for example made of aluminum or copper, in order to efficiently conduct heat to the measurement element.

Still with reference to FIG. 2, the sensor is mounted in a reception space formed in the rotor of the electric machine to measure the temperature of a magnet of the rotor, notably when said rotor is set into rotation.

The dimensions of the reception space are substantially equal to or slightly greater than those of the sensor so that the sensor can be housed in the reception space without any clearance, for example, by force.

Still with reference to FIG. 2, the rotor comprises a magnet embedded flush with the reception space where the conduction element emerges, so that the temperature measured by the measurement element is that of the magnet and notably varies with that of the magnet via the thermal conduction element.

FIG. 3 illustrates an example of an electric machine comprising a reception space housing a sensor as described above.

FIG. 3 is an example of an electric machine for a motor vehicle. The electric machine is configured to be mounted in the vehicle in order to set into rotation the wheels of said vehicle.

The electric machine comprises a stator, a rotor, and a sensor as described above.

The rotor is configured to rotate about a longitudinal axis.

In this example, the rotor comprises an integral shaft extending along the longitudinal rotation axis Y

and containing a first shaft portion and a second shaft portion that are connected to the stator by means of a system of bearings.

The stator comprises a control stage and a main piezoelectric transceiver configured to transmit the ultrasonic power supply signal to the sensor and to receive the ultrasonic response signal.

The control stage is configured to control the position of the rotor and the temperature based on the value of the parameter contained in the ultrasonic response signal received by the main piezoelectric transceiver.

It should be noted that the sensor could be used for other applications, for example in a battery or a pack of batteries or a fuel cell.

### Example of Sensor Mounting

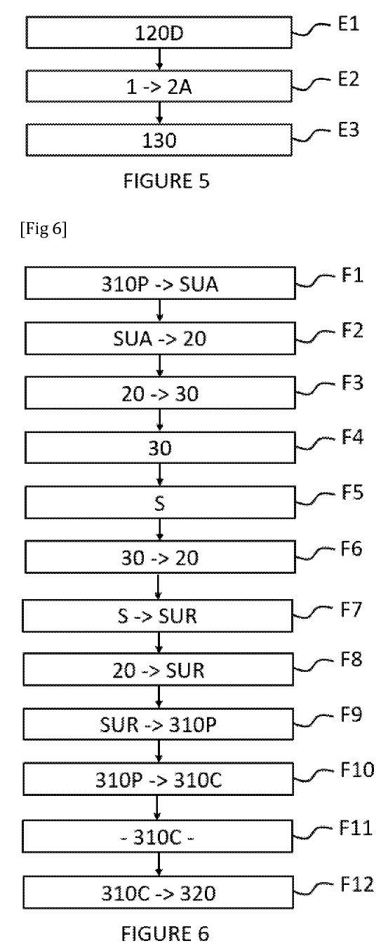

Firstly, with reference to FIGS. 4 and 5, in a step, an adhesive is applied to the distal end of the body of the sensor and optionally to the lateral face of the body of the sensor.

As the distal end progresses into the reception space, and notably when it reaches the bottom of the reception space, fluids such as air, and possibly excess adhesive and/or water present in the reception space, are discharged through the discharge ducts in a step so that the sensor fully occupies the reception space without any clearance, notably at the distal end (FIG. 4, center). In other words, the conical distal end allows fluids to be directed toward the discharge ducts as the sensor is inserted into the reception space and notably allows air to be expelled that could otherwise interfere with the reception and transmission of ultrasonic signals by the piezoelectric element.

Once fully inserted into the reception space, without any residual clearance, the adhesive dries and secures the sensor to the walls of the reception space so that it remains firmly secured in the rotor, notably when the rotor is set into rotation (FIG. 4, right-hand side).

### Example of implementation in the case of an electric machine

With reference to FIG. 6, when a temperature measurement has to be taken by the sensor, notably when the rotor is set into rotation, the control stage commands the main piezoelectric transceiver to transmit an ultrasonic power supply signal to the sensor in a step.

The piezoelectric element of the sensor receives the ultrasonic power supply signal in a step and then electrically powers the measurement element using the electrical energy contained in the ultrasonic power supply signal received in a step.

The measurement element, when electrically powered by the piezoelectric element, measures the parameter in a step and generates a measurement signal representing the value of said parameter at a given time in a step, which it transmits to the piezoelectric element in a step. In this example, the resistance of the resistor varies as a function of the temperature of the magnet connected to the measurement element by the conduction element, and the resistance value of the resistor therefore corresponds to a given temperature, which is predetermined empirically, for example. The measurement signal then corresponds to the signal representing the voltage measured across the terminals of the resistor.

The piezoelectric element then converts the measurement signal into an ultrasonic response signal in a step and then transmits said ultrasonic response signal in a step.

The ultrasonic response signal is received by the main piezoelectric transceiver in a step and is then transmitted to the control stage in a step.

The control stage then analyzes the received ultrasonic measurement signal to determine the measured temperature value in a step and then controls the position of the rotor, in a manner known per se, as a function of the determined temperature value, for example using a predetermined correspondence table stored in its memory zone and providing the temperature value as a function of the voltage value provided in the ultrasonic response signal, in a step.

The invention therefore allows a parameter to be measured with the assistance of a remote module remotely powered with electrical energy, thus avoiding the use of a battery to be changed, which is particularly advantageous in the case of a rotor of an electric machine.

1. A sensor for measuring a parameter for a motor vehicle, said sensor comprising an elongated body comprising at least one lateral face extending between a distal end, having a raised shape projecting from said at least one lateral face , and a proximal end, said body comprising, along the at least one lateral face , at least one fluid discharge channel extending from the distal end to the proximal end, said sensor further comprising a piezoelectric element and a measurement element, said piezoelectric element being mounted inside the body adjacent to the distal end and being configured to receive an ultrasonic power supply signal and to electrically power said measurement element from said ultrasonic power supply signal, the measurement element being mounted inside the body while being electrically connected to the piezoelectric element and being configured, when electrically powered by the piezoelectric element, to measure the parameter, to generate a measurement signal representing the value of said parameter at a given time, and to transmit said measurement signal to the piezoelectric element, said piezoelectric element being configured to convert said measurement signal into an ultrasonic response signal and to transmit said ultrasonic response signal.

2. The sensor as claimed in claim 1, further comprising a conduction element connecting the measurement element to the outside of the sensor, preferably through one of its lateral faces.

3. The sensor as claimed in claim 2, wherein the conduction element is a thermal conduction element, preferably made of aluminum or copper.

4. The sensor as claimed in claim 1, wherein the piezoelectric element extends along a plane.

5. The sensor as claimed in claim 1, wherein the distal end has a pointed shape.

6. The sensor as claimed in claim 1, wherein the at least one discharge channel is a groove formed on the surface of the body of the sensor or even a duct formed in a lateral face of the body of the sensor.

7. A casing for a sensor as claimed in claim 1, said casing comprising a molding of material defining a space in which said sensor is mounted.

8. An electric machine for a motor vehicle, said electric machine comprising a stator a rotor and a sensor as claimed in claim 1, said electric machine being configured to be mounted in said vehicle in order to set into rotation the wheels of said vehicle, in which electric machine a main piezoelectric transceiver configured to transmit the ultrasonic power supply signal to the sensor and to receive the ultrasonic response signal (SUR) is mounted on the stator and the sensor is mounted inside the rotor.

9. A motor vehicle comprising a sensor as claimed in claim 1.

10. A method for mounting a sensor as claimed in claim 1 in a reception space of a motor vehicle, said reception space being dimensioned to receive said sensor without any clearance, said method comprising:
applying an adhesive at least to the distal end of the body of the sensor;
inserting the distal end of the sensor into the reception space;
discharging when the distal end of the sensor reaches the bottom of the reception space the fluids present in the reception space through the at least one discharge channel so as to secure the sensor in the reception space.
